(19) United States
(12) Patent Application Publication
(10) Pub. No.: US 2014/0016310 A1
(43) Pub. Date: Jan. 16, 2014

(54) LED PROJECTION LAMP

(71) Applicant: Haijun Xie, Shanghai (CN)

(72) Inventor: Haijun Xie, Shanghai (CN)

(73) Assignee: SHANGHAI GRANDAR LIGHT ART & TECHNOLOGY CO., LTD, Shanghai (CN)

(21) Appl. No.: 14/009,097

(22) PCT Filed: Jan. 18, 2012
(86) PCT No.: PCT/CN2012/070513

§ 371 Date: Sep. 30, 2013

(30) Foreign Application Priority Data
Apr. 1, 2011 (CN) 201110082990.4

(51) Int. Cl. F21K 99/00

(52) U.S. Cl. CPC F21K 9/54
USPC 362/231; 362/240

(57) ABSTRACT

The present invention disclosed an LED projection lamp, including a lamp bracket, where the LED projection lamp further includes a plurality of light mixing units; the light mixing units each include a lens assembly and a plurality of LEDs, and are fixed on a surface of the lamp bracket in a disperse manner; and each position on the surface of the bracket has a different spatial angle. In the present invention, the light mixing units are fixed at fixation surfaces with different inclined angles on the lamp bracket, so that the light mixing units are arranged in a disperse manner, hence realizing different pixel effects. The white light LEDs and colored-light LEDs are used in coordination, so that the full-color adjustment function is implemented on each pixel while sufficient illuminance is provided; in addition, through a light mixing function between the single color LED and white-light LED, the color rendering index is improved to 90% or higher.

### BACKGROUND OF THE PRESENT INVENTION

1. Field of Invention

The present invention relates to the field of light emitting diode (LED) semiconductor lighting, and specifically to an LED projection lamp capable of implementing a pixel function.

2. Description of Related Arts

As is known to all, LEDs, as a new generation of green lighting source, have advantages such as high luminous efficiency, a long service life, and being safe, energy-saving, environmental-friendly, and bright in color, and is widely applied in indoor and outdoor illumination, backlight, medical treatment, transportation, and other fields.

However, despite the long service life and low energy consumption of the LED light source, the LED is approximately a point light source, and can only emit light rays towards half of a space; the illuminance is unevenly distributed. Light energy is distributed as such that the middle is bright and the periphery is dark. In addition, the LED light source produces intense glare, which is visually uncomfortable. Therefore, an optical device which has been subjected to optical design once or multiple times of optical design needs to be added on the LED light source to provide the illuminance uniformity and luminance uniformity of the LED light source, and eliminate glare, thereby improving the visual comfort.

To solve the foregoing problems, a light guide plate is adopted in the prior art to refract light rays, so as to achieve the effect of uniformizing the illuminance and reducing glare. However, it only achieves a single white light effect, and is incapable of implementing full-color lighting, not to mention the effect of pixel display. Moreover, in the prior art, many single color LEDs are densely arranged to implement a mixture of colored-light, thereby realizing full-color lighting. However, this method fails to achieve full-color random adjustment, and does not have a pixel effect.

With the application of LED light sources, the requirement on the lighting effect thereof is stricter. Rich color conditioning, pixel effect adjustment, and the uniformity and softness of light rays all become important breakthrough points of the LED projection lamp.

Therefore, it is of great significance to develop an LED projection lamp having full-color lighting and pixel effects.

### SUMMARY OF THE PRESENT INVENTION

The technical problem to be solved by the present invention is to provide an LED projection lamp, so as to overcome the defect that the prior art is incapable of implementing full-color lighting and pixel effects.

The present invention solves the above technical problem through the following technical solution: an LED projection lamp, including a lamp bracket, where the LED projection lamp further includes a plurality of light mixing units; the light mixing units each include a lens assembly and a plurality of LEDs, and are fixed on a surface of the lamp bracket in a disperse manner; and each position on the surface of the bracket has a different spatial angle.

LEDs are fixed, for example, surface-mounted, along the surface of the bracket; because the surface of the bracket has different spatial angles, LED lamp light is split, thereby forming different pixels. Similarly, the light mixing units form a pixel spot.

Preferably, each light mixing unit further includes an aluminum substrate; the plurality of LEDs is fixed on the aluminum substrate, and the lens assembly covers the plurality of LEDs from above, and is fixed on the aluminum substrate.

Preferably, at least two locating holes are provided at a periphery of the aluminum substrate, and at least two locating angles are provided at a periphery of the lens assembly; the locating angles and the locating holes are corresponding to a fastener.

The aluminum substrate has a desirable radiation effect, to prevent an LED lamp from being overheated.

Preferably, the surface of the bracket is arc-shaped, polyhedral, or umbrella-shaped.

Preferably, a plurality of fixation surfaces is arranged on the surface of the bracket in a disperse manner, and the plurality of light mixing units is correspondingly fixed on the plurality of fixation surfaces.

Preferably, a center of the fixation surface is provided with a through hole.

The through hole is used for wiring of LED lamp wires, thereby facilitating neat arrangement of the lamp wires.

Preferably, the aluminum substrate, the lens assembly, and the fixation surface match with each other.

Preferably, a fixing manner between the aluminum substrate and the surface of the bracket is surface mounting, riveting, threaded connection, or integral forming.

Preferably, the plurality of light mixing units is distributed on the surface of the bracket in a circular arrangement manner, a polygonal arrangement manner, or an array arrangement manner.

Different arrangement manners form different spatial angles, thereby implementing different pixel effects.

Preferably, a radiating rib is disposed below the lamp bracket.

The radiating rib further improves the radiation and guarantees a desirable radiation effect.

Preferably, the lens assembly is made of acrylic or PC material.

Preferably, the plurality of LEDs includes a plurality of white light LEDs and colored-light LEDs.

Through blending colored LED light rays with white LED light rays, full-color adjustment is implemented; moreover, a light mixing function of a single pixel spot, and color temperature adjustment and color rendering index adjustment of a single spot are also realized.

The present invention has the following positive improvement effects:

1. The light mixing units are fixed at fixation surfaces with different inclined angles on the lamp bracket, so that the light mixing units are arranged in a disperse manner, hence realizing different pixel effects.

2. The white light LEDs and colored-light LEDs are used in coordination, so that the full-color adjustment function is implemented on each pixel while sufficient illuminance is provided; in addition, through a light mixing function between the single color LED and white-light LED, the color rendering index is improved to 90% or higher.

3. The original features of the LED lamp are brought into full play, and the LED lamp is energy saving compared with a fluorescent lamp (the power consumption is 1/10 that of the fluorescent lamp), is impact-resisting, is not broken easily, and has a long service life (the service life is about 20 times that of the filament lamp and fluorescent lamp).

4. The radiation performance is desirable; the LED lamp is environmental friendly, does not pollute the environment, does not flash, and has a fast startup speed.

### BRIEF DESCRIPTION OF THE DRAWINGS

FIG. 1 is a schematic view of a lamp bracket in an exemplary embodiment of the present invention.

FIG. 2 is a schematic view of a lens assembly in an exemplary embodiment of the present invention.

FIG. 3 is a side view of a lens assembly in an exemplary embodiment of the present invention.

FIG. 4 is a schematic view of an overall structure of an exemplary embodiment of the present invention.

### DETAILED DESCRIPTION OF THE PREFERRED EMBODIMENTS

Exemplary embodiments of the present invention are provided below with reference to the accompanying drawings, so as to describe the technical solution of the present invention in detail.

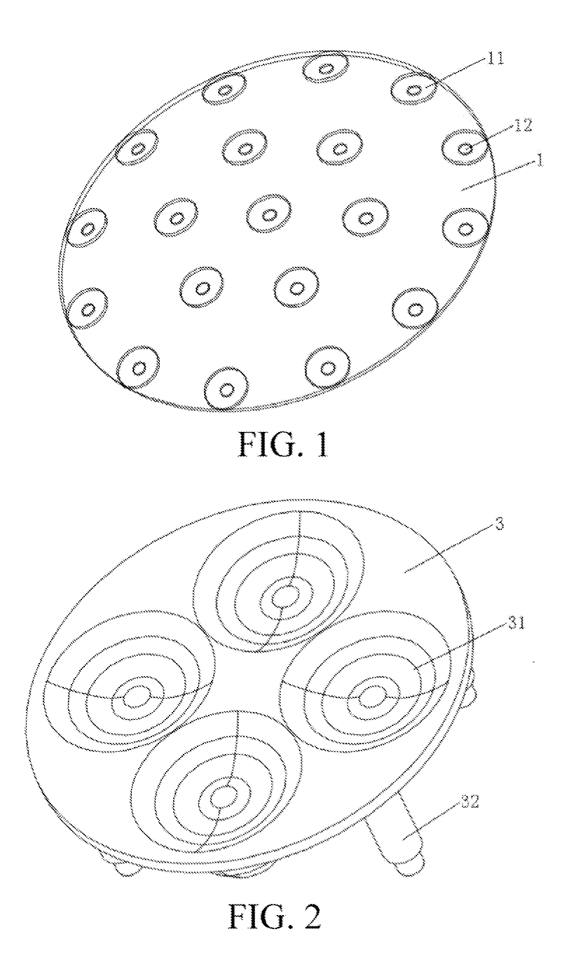

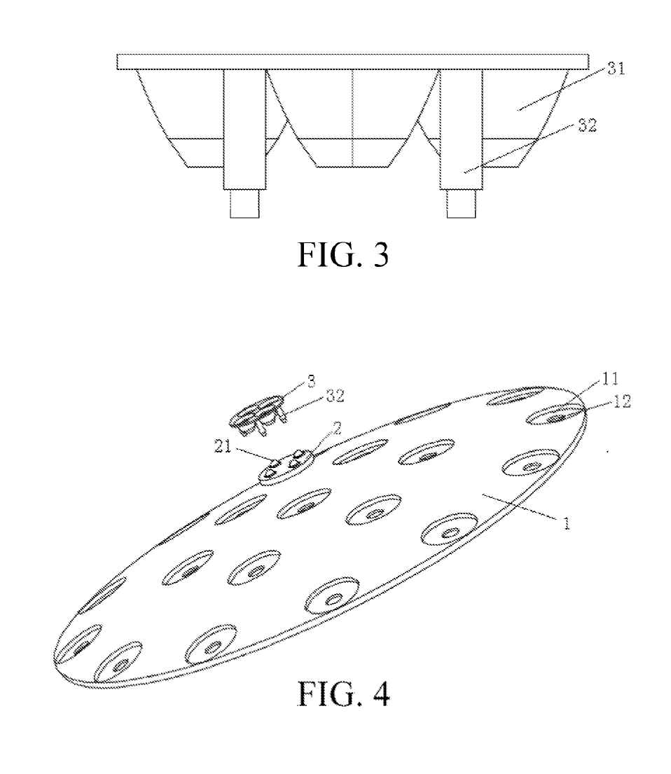

Referring to FIG. 1 to FIG. 4, a lamp base of an LED projection lamp in this embodiment has an arc-shaped bracket 1, and the appearance of the arc-shaped bracket is a disk-like aluminum alloy radiator with a plurality of cambered or multi-folded fixation surfaces 11 disposed on a surface thereof Each fixation surface 11 is provided with a through hole 12 at the center, and an aluminum substrate 2 matching the shape of the surface may be placed at each fixation surface.

The arc-shaped bracket 1 may have a single structure or a split structure. Definitely, the bracket 1 may also be polyhedral or umbrella-shaped. In addition, other shapes with different spatial angles may also be used to achieve the pixel effect.

The position and angle of the aluminum substrate 2 are determined through a locating angle. Multiple single color LEDs, for example, four single color LEDs, are fixed on the aluminum substrate 2 (as shown in FIG. 4). The color of an LED may be any single primary color, such as red, green, blue, and white. Light rays of the LED may go out of the through hole 12 in the fixation surface 11 to connect a control circuit at a lower portion of a base.

A lens assembly 3 formed of multiple reflection cups 31, such as a lens assembly formed of four reflection cups 31, is fixed on the aluminum substrate 2 (as shown in FIG. 1). The lens assembly 3 covers a plurality of LED light sources 21 from above, and is fixed on the aluminum substrate 2. At least two locating holes are provided at a periphery of the aluminum substrate 2, and at least two locating angles 32 are provided at a periphery of the lens assembly 3. In this way, the locating angles 32 and the locating holes are corresponding to a fastener, thereby being precisely located and forming a pixel spot. The lens assembly 3 is used to precisely mixing light emitted by the four single color LEDs to achieve a full-color lighting effect. To guarantee a light ray reflecting effect of the lens, a material of the lens assembly is an acrylic or a PC material.

An aluminum substrate 2, a plurality of LED light sources 21, and a lens assembly 3 form a light mixing unit. The light mixing unit is fixed on the fixation surface of the lamp bracket 1 in a disperse manner as a whole, and may be distributed in a circular arrangement manner, a polygonal arrangement manner, or an array arrangement manner.

Subsequently, the aluminum substrate 2 and the LED lens assembly 3 are fixed on the fixation surface 11 of the arc-shaped bracket 1 by using glue or in other manners. Each fixation surface 11 has a different spatial angle and inclination direction, each fixation surface is inclined from the center towards the edge, and the inclination angle at an outer edge is greater than the indication angle at an inner layer. Therefore, the mixed full-color spot is split at a lighting surface, thereby achieving a pixel effect.

Definitely, to ensure firm fixing between the components, the aluminum substrate 2, the lens assembly 3, and the fixation surface 11 match with each other. A fixing manner among the aluminum substrate 2, the lens assembly 3, and the fixation surface 11 may be surface mounting, riveting, threaded connection, or integral forming with the arc-shaped bracket 1. Moreover, a radiating rib may be disposed below the lamp bracket 1, so as to further enhance the radiation effect of the LED projection lamp.

In addition, the plurality of LEDs in each light mixing unit includes white-light LEDs and colored-light LEDs. The colored-light LEDs are single color light sources, and generate different colors when being mixed with each other. Then, through blending with the white light LED, different tones are formed, hence realizing full-color display. This manner not only achieves full-color display of each spot, but also implements a light mixing function of a single pixel spot, color temperature adjustment of a single pixel spot, and adjustment of color rendering index of light. All these functions can be controlled and set through a control circuit.

In summary, the LED projection lamp of the present invention not only realizes the pixel effect, but also realizes full-color display and adjustment on colors. The structure thereof is simple and easy to implement, and the performance of the LED projection lamp is significantly improved.

Specific implementation manners of the present invention are described above, but a person skilled in the art should understand that these implementation manners are merely exemplary, and the protection scope of the present invention is subject to the appended claims. All alterations or modifications made by a person skilled in the art to these implementation manners without departing from the principle and essence of the present invention shall fall within the protection scope of the present invention.

1. An LED projection lamp, comprising a lamp bracket, wherein the LED projection lamp further comprises a plurality of light mixing units; the light mixing units each comprise a lens assembly and a plurality of LEDs, and the light mixing units are fixed on a surface of the lamp bracket in a disperse manner; and spatial angels of different portions of the lamp bracket surface differ from each other. spatial angels of different portions of the lamp bracket surface differ from each other.

2. The LED projection lamp according to claim 1, wherein each light mixing unit further comprises an aluminum substrate; the plurality of LEDs is fixed on the aluminum substrate, and the lens assembly covers the plurality of LEDs from above, and is fixed on the aluminum substrate.

3. The LED projection lamp according to claim 2, wherein at least two locating holes are provided at a periphery of the aluminum substrate, and at least two locating angles are provided at a periphery of the lens assembly; the locating angles and the locating holes are corresponding to a fastener.

4. The LED projection lamp according to claim 1, wherein the surface of the bracket is arc-shaped, polyhedral, or umbrella-shaped.

5. The LED projection lamp according to claim 2, wherein a plurality of fixation surfaces are arranged on the surface of the bracket in a disperse manner, and the plurality of light mixing units is correspondingly fixed on the plurality of fixation surfaces.

6. The LED projection lamp according to claim 5, wherein a center of the fixation surface is provided with a through hole.

7. The LED projection lamp according to claim 5, wherein the aluminum substrate, the lens assembly, and the fixation surface mutuamatch with each other.

8. The LED projection lamp according to claim 2, wherein a fixing manner between the aluminum substrate and the surface of the bracket is surface mounting, riveting, threaded connection, or integral forming.

9. The LED projection lamp according to claim 2, wherein the plurality of light mixing units is distributed on the surface of the bracket in a circular arrangement manner, a polygonal arrangement manner, or an array arrangement manner.

10. The LED projection lamp according to claim 1, wherein a radiating rib is disposed below the lamp bracket.

11. The LED projection lamp according to claim 1, wherein the lens assembly is made of acrylic or PC material.

12. The LED projection lamp according to claim 1, wherein the plurality of LEDs comprises a plurality of white-light LEDs and colored-light LEDs.

13. The LED projection lamp according to claim 12, wherein the plurality of white-light LEDs and colored-light LEDs are combined to adjust a color temperature and a color rendering index of the lamp.

14. The LED projection lamp according to claim 3, wherein a fixing manner between the aluminum substrate and the surface of the bracket is surface mounting, riveting, threaded connection, or integral forming.
